(19) United States
(12) Patent Application Publication
(10) Pub. No.: US 2020/0276819 A1
(43) Pub. Date: Sep. 3, 2020

(54) INKJET RECORDING APPARATUS AND MAINTENANCE METHOD

(71) Applicant: KONICA MINOLTA, INC., Tokyo (JP)

(72) Inventor: Yohei ITO, Tokyo (JP)

(21) Appl. No.: 16/800,010

(22) Filed: Feb. 25, 2020

(30) Foreign Application Priority Data
Feb. 28, 2019 (JP) 2019-036479

(51) Int. Cl. B41J 2/165

(52) U.S. Cl. CPC B41J 2/16535

(57) ABSTRACT

An inkjet recording apparatus includes an ink ejection head that includes an ink ejector with a nozzle to which ink is supplied, a hardware processor that causes the ink ejector to perform an ejecting action of ejecting ink from the nozzle and/or an projecting action of projecting ink from an opening of the nozzle, and a wiping unit that performs a wiping action of wiping a nozzle opening surface of the ink ejection head, the opening of the nozzle being formed on the nozzle opening surface. The hardware processor controls an operation of the ink ejector so as to cause the ink ejector to perform the ejecting action and/or the projecting action at a timing according to a wiping position of the wiping unit during the wiping action of the wiping unit.

### CROSS-REFERENCE TO RELATED APPLICATIONS

The present invention claims priority under 35 U.S.C. § 119 to Japanese Patent Application No. 2019-036479 filed on Feb. 28, 2019, the entire contents of which are incorporated herein by reference.

### BACKGROUND

### Technological Field

The present invention relates to an inkjet recording apparatus and a maintenance method.

### Description of the Related Art

Conventionally, there has been an inkjet recording apparatus that records an image by ejecting ink from openings of nozzles provided in an ink ejection head for ink to land at a desired position. In this inkjet recording apparatus, mist-like ink (ink mist) generated by ink ejection or part of ejected ink sometimes adheres to a nozzle opening surface of the ink ejection head on which the nozzle openings are formed. A technique of wiping and cleaning the nozzle opening surface with a wiping member such as a blade or a fabric is employed against this problem.

In this technique, in a case where there are foreign substances such as thickened ink and contaminants on the nozzle opening surface, these foreign substances adhere to the inside of the nozzle when the nozzle opening surface is wiped with the wiping member. That leads to a problem of defection ink ejection from the nozzle. Against this problem, Japanese Patent Application Laid-Open No. 2004-291618 discloses a technique for suppressing adhesion of foreign substances to the inside of nozzles by applying pressure from the inside to ink in each nozzle and wiping the nozzle opening surface after ink is projected from the opening of each nozzle outward.

### SUMMARY

However, it is not easy to control the state of ink so that ink does not drip while ink is projected outward from the opening of the nozzle, and ink may unintentionally drip from the nozzle while the nozzle opening surface is being wiped. Therefore, ink mist generated by dripping of ink or part of dripped ink may adhere to a component of the inkjet recording apparatus such as the nozzle opening surface after wiping, thereby causing contamination. Therefore, in the above-mentioned prior art, it is difficult to effectively clean the nozzle opening surface while suppressing contamination of the inkjet recording apparatus.

An object of the present invention is to provide an inkjet recording apparatus and a maintenance method that enables effective cleaning of the nozzle opening surface while contamination of the inkjet recording apparatus is suppressed.

To achieve at least one of the above-mentioned objects, according to an aspect of the present invention, an inkjet recording apparatus reflecting one aspect of the present invention includes:

an ink ejection head that includes an ink ejector with a nozzle to which ink is supplied;

a hardware processor that causes the ink ejector to perform an ejecting action of ejecting ink from the nozzle and/or an projecting action of projecting ink from an opening of the nozzle; and

a wiping unit that performs a wiping action of wiping a nozzle opening surface of the ink ejection head, the opening of the nozzle being formed on the nozzle opening surface;

wherein the hardware processor controls an operation of the ink ejector so as to cause the ink ejector to perform the ejecting action and/or the projecting action at a timing according to a wiping position of the wiping unit during the wiping action of the wiping unit.

To achieve at least one of the above-mentioned objects, according to an aspect of the present invention,

an inkjet recording apparatus includes:
an ink ejection head that includes an ink ejector with a nozzle to which ink is supplied;
a hardware processor that causes the ink ejector to perform an ejecting action of ejecting ink from the nozzle and/or an projecting action of projecting ink from an opening of the nozzle; and
a wiping unit that performs a wiping action of wiping a nozzle opening surface of the ink ejection head, the opening of the nozzle being formed on the nozzle opening surface; and

a maintenance method of the inkjet recording apparatus reflecting one aspect of the present invention includes:
causing the wiping unit to perform the wiping action; and
causing the ink ejector to perform the ejecting action and/or the projecting action at a timing corresponding to a wiping position of the wiping unit during the wiping action of the wiping unit.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 shows a schematic configuration of an inkjet recording apparatus.

FIG. 2 shows a configuration of the head unit.

FIG. 3 is a cross-sectional view of the ink ejection head as viewed from the lateral side.

FIG. 4A is a cross-sectional view of a nozzle in an ejecting action of an ink ejector.

FIG. 4B is a cross-sectional view of the nozzle in the ejecting action of the ink ejector.

FIG. 4C is a cross-sectional view of the nozzle in the ejecting action of the ink ejector.

FIG. 5A is a cross-sectional view of the nozzle in a projecting action of the ink ejector.

FIG. 5B is a cross-sectional view of the nozzle in the projecting action of the ink ejector.

FIG. 6 shows a configuration of a maintenance unit.

FIG. 7 shows a configuration of a wiping member detector.

FIG. 8 shows a main functional configuration of the inkjet recording apparatus.

FIG. 9A illustrates a maintenance operation.

FIG. 9B illustrates the maintenance operation.

FIG. 9C illustrates the maintenance operation.

FIG. 10 illustrates a start timing of ink ejection from each nozzle in the maintenance operation.

FIG. 11A illustrates an effect of the maintenance operation in an embodiment.

FIG. 11B illustrates an effect of the maintenance operation of the embodiment.

FIG. 11C illustrates an effect of the maintenance operation of the embodiment.

FIG. 12 is a flowchart of control steps of the maintenance process.

FIG. 13 is a flowchart of control steps of the maintenance process according to Modification 1.

### DETAILED DESCRIPTION OF THE EMBODIMENTS

Embodiments of an inkjet recording apparatus and a maintenance method according to the present invention are described below with reference to the drawings. However, the scope of the invention is not limited to the disclosed embodiments.

### <Configuration of Inkjet Recording Apparatus>

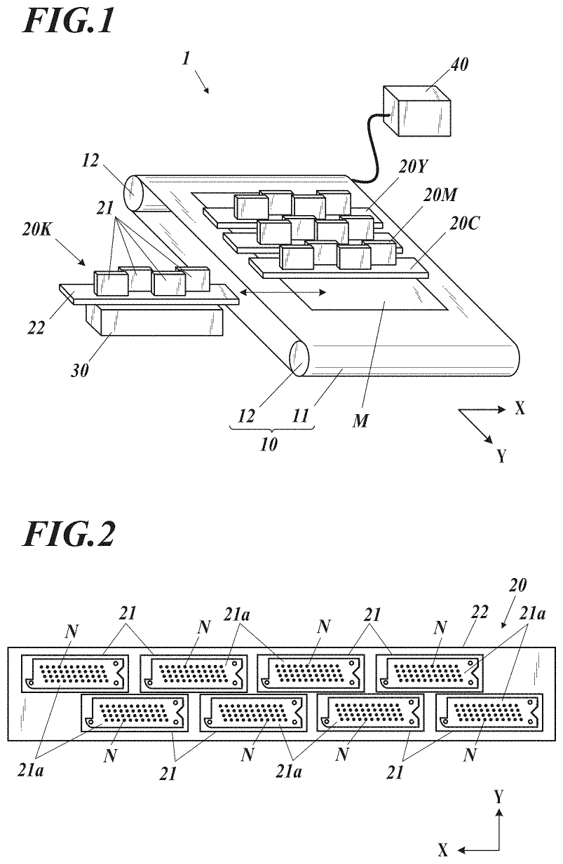

FIG. 1 shows a schematic configuration of an inkjet recording apparatus 1 according to an embodiment of the present invention.

The inkjet recording apparatus 1 includes a conveyance unit 10, head units 20Y, 20M, 20C, and 20K (hereinafter, also referred to as head units 20 when they are not distinguished from each other), a maintenance unit 30 (wiping unit), and a controller 40 (hardware processor).

The conveyor 10 includes a conveyance belt 11 and a pair of conveyance rollers 12. Each of the conveyance rollers 12 rotates about a rotation axis parallel to the X direction in FIG. 1, being driven by a conveyance motor (not shown). The conveyance belt 11 is a ring-shaped belt with the inner side being supported by the pair of conveyance rollers 12, and the conveyance belt 11 circularly moves as the conveyance rollers 12 rotate. In the inkjet recording apparatus 1, in a state where a recording medium M is mounted on the conveyance belt 11, the conveyance belt 11 circularly moves at a speed corresponding to the rotation speed of the conveyance rollers 12, thereby conveying the recording medium M in the moving direction of the conveyance belt 11 (the conveying direction: the Y direction in FIG. 1). As the recording medium M, various media such as paper, resin plate, and fabric can be used.

The head unit 20 ejects ink from the nozzles onto the recording medium M conveyed by the conveyance belt 11 based on image data so as to record an image on the recording medium M. In the inkjet recording apparatus 1 in the present embodiment, four head units 20Y, 20M, 20C, and 20K respectively corresponding to four colors of ink of yellow (Y), magenta (M), cyan (C), and black (K) are arranged in order at predetermined intervals from the upstream side in the conveying direction of the recording medium M. The number of the head units 20 may be fewer or more than four.

FIG. 2 shows a configuration of the head unit 20, and is a plan view of the head unit 20 as viewed from the side facing the outer peripheral surface of the conveyance belt 11. The head unit 20 includes a plate-shaped support 22 and a plurality of (eight in this embodiment) ink ejection heads 21 fitted in through holes on the support 22 to be fixed to the support 22. Each of the ink ejection heads 21 is fixed to the support 22 in a state where the nozzle opening surface 21a provided with the openings of the nozzles N is exposed through the through hole of the support 22 toward the conveyance belt 11.

Each ink ejection head 21 has the nozzles N arranged at equal intervals in the direction intersecting the conveying direction of the recording medium M (in the present embodiment, in the width direction (X direction) orthogonal to the conveying direction). In the present embodiment, the ink ejection heads 21 has four rows (nozzle rows) of the nozzles N, in each of which nozzles N are one-dimensionally arranged at equal intervals in the width direction. These four nozzle rows are arranged such that the positions of the nozzles N in the width direction are shifted from each other so as not to overlap in the width direction. The number of the nozzle rows included in the ink ejection head 21 is not limited to four, and may be fewer or more than four.

The eight ink ejection heads 21 in the head unit 20 are arranged in a staggered pattern so that the nozzles N are arranged continuously in the width direction. The arrangement range of the nozzles N included in the head unit 20 in the width direction covers the width of the image recording range of the recording medium M in the width direction. The head unit 20 is used at a fixed position in image recording, and ink is ejected from the nozzles N at predetermined intervals in the conveying direction in accordance with the circular movement of the conveyance belt 11, thereby recording an image in a single-pass mode.

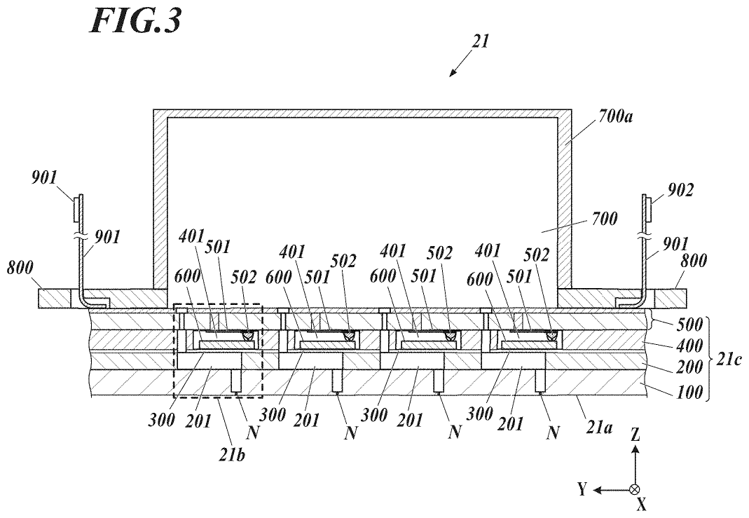

FIG. 3 is a cross-sectional view of the ink ejection head 21 as viewed from the lateral surface side in the X direction. FIG. 3 shows a cross section of the ink ejection head 21 that includes four nozzles N included respectively in four nozzle rows.

The ink ejection head 21 includes a head chip 21c, a common ink chamber 700, a support plate 800, a wiring member 901, a driving circuit 902, and the like.

The head chip 21c is provided for ejecting ink from the nozzles N and configured by a plurality of (in this embodiment, four) plate-shaped plates that are layered. The lowermost plate in the head chip 21c is a nozzle plate 100. The nozzles N are formed in the nozzle plate 100, and ink can be ejected substantially perpendicularly to the nozzle opening surface 21a (the exposed surface of the nozzle plate 100) on which the openings of the nozzles N are formed. The nozzle opening surface 21a is coated with a water-repellent film (ink-repellent film). As the water-repellent film, an organic film of a fluorine-based resin is mainly used. By coating the nozzle opening surface 21a with the water-repellent film, it is possible to make it difficult for ink mist to adhere to the nozzle opening surface 21a.

On the opposite side of the nozzle opening surface 21a of the nozzle plate 100, a pressure chamber plate 200 (chamber plate), a spacer plate 400, and a wiring plate 500 are bonded and stacked in an order upward (in the +Z direction). Hereinafter, the nozzle plate 100, the pressure chamber plate 200, the spacer plate 400, and the wiring plate 500 are referred to as a laminated plate(s) 100, 200, 400, and 500, respectively or collectively.

The laminated plates 100, 200, 400, and 500 are provided with ink flow paths communicating to the nozzles N, and are open on the surface of the wiring plates 500 on the exposed side (the +Z direction-side). The common ink chamber 700 is provided on the exposed surface of the wiring plate 500 so as to cover all the openings. Ink stored in the ink chamber forming member 700a of the common ink chamber 700 is supplied to each of the nozzles N through the opening of the wiring plate 500.

A pressure chamber 201 is provided halfway on each ink flow path. The pressure chamber 201 is provided so as to penetrate the pressure chamber plate 200 in the vertical direction (the Z direction), and the upper wall of the pressure chamber 201 is configured by a diaphragm 300 provided between the pressure chamber plate 200 and the spacer plate 400. A pressure change is given to ink in the pressure chamber 201 by deformation of the diaphragm 300 (the pressure chamber 201), which is caused by displacement (deformation) of a piezoelectric element 600 in the space 401 adjacent to the pressure chamber 201 via the diaphragm 300. By applying an appropriate pressure change to ink in the pressure chamber 201, ink in the ink flow path is ejected as a droplet from the nozzle N communicating to the pressure chamber 201. In addition, by adjusting the pressure change of ink in the pressure chamber 201, the ink surface (meniscus) in the opening of the nozzle N can be fluctuated to an extent that does not form an ink droplet, so that ink projects from the opening.

Ink in the ink flow path is pulled toward the common ink chamber 700 by a negative pressure of a negative pressure generating means (not shown) so that ink does not drip from the nozzles N that are not ejecting ink.

The support plate 800, which is bonded to the upper surface of the head chip 21c, holds the ink chamber forming member 700a of the common ink chamber 700. The support plate 800 has an opening of substantially the same size and shape as the opening of the lower surface of the ink chamber forming member 700a, and ink in the common ink chamber 700 is supplied to the upper surface of the head chip 21c through the opening of the lower surface of the ink chamber forming member 700a and the opening of the support plate 800.

The wiring member 901, which is, for example, a flexible printed circuit (FPC), is connected to the wiring of the wiring board 500. Each piezoelectric element 600 is displaced by a drive signal transmitted to a wiring 501 and the connection unit 502 (conductive member) in the space 401 via the wiring member 901. The wiring member 901 is drawn out through the support plate 800 and connected to the driving circuit 902.

The driving circuit 902 receives a control signal from the controller of the inkjet recording apparatus, power supply from the power supply unit, and the like, and outputs an appropriate drive signal for the piezoelectric elements 600 to the wiring member 901. The driver 902 includes an integrated circuit (IC) or the like.

Of the components of the ink ejection head 21, ink ejectors 21b are configured by a mechanism which is provided for each of the nozzles N to eject ink from the nozzle N. Specifically, each of the ink ejectors 21b includes the nozzle N, the ink flow path including the pressure chamber 201 communicating to the nozzle N, the piezoelectric element 600, the wiring 501, and the connection unit 502.

Each of the ink ejectors 21b performs an ejecting action of ejecting ink from the nozzle N and a projecting action of projecting ink from the opening of the nozzle N under the control of the controller 40. The projecting action is to project ink from the opening by applying pressure to ink in the pressure chamber 201 to fluctuate the ink surface. Hereinafter, the ejecting action and the projecting action are collectively referred to as an “ink-state changing action”. By the ejecting action of the ink ejector 21b, ink can be ejected from the nozzles N to record an image on the recording medium M. By the projecting action of the ink ejector 21b, it is possible to suppress occurrence of a problem that the solvent evaporates from the surface of ink and the viscosity of ink rises when ink is not ejected for a long time.

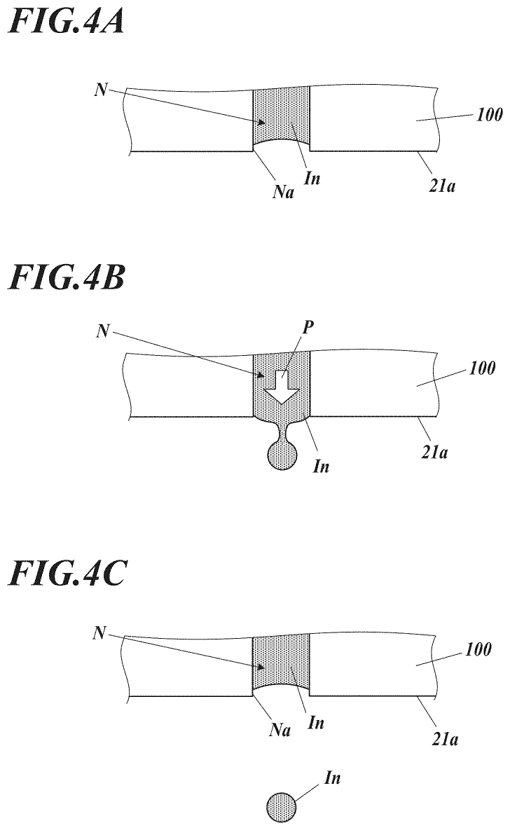

FIG. 4A to FIG. 4C are cross-sectional views of the nozzles N showing the ejecting action of the ink ejector 21b.

In the ejecting action, a pressure P caused by displacement of the piezoelectric elements 600 is applied to the ink In so that the state of ink is changed from the steady state shown in FIG. 4A (or in a state where a negative pressure is applied to ink In in the nozzles N to draw the ink surfaces upward from the steady state) to the state shown in FIG. 4B, whereby droplets of ink In are ejected downward (FIG. 4C).

The ink ejector 21b repeats the ejecting action shown in FIG. 4A to FIG. 4C, thereby continuously ejecting droplets of the ink In. The ejection frequency of the ink In may be, for example, about 30 kHz, and is adjustable by changing the frequency of the drive signals applied to the piezoelectric elements 600.

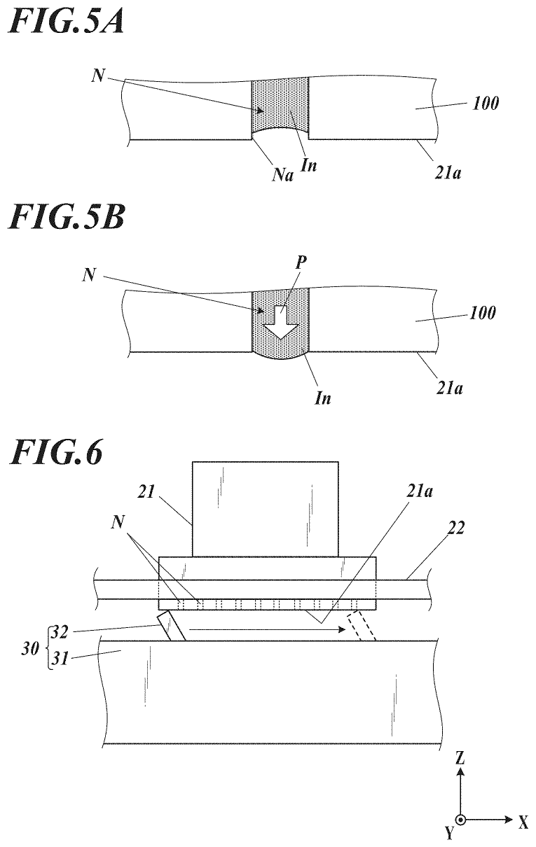

FIG. 5A and FIG. 5B are cross-sectional views of the nozzle N showing the projecting action of the ink ejector 21b.

In the projecting action, the pressure P due to displacement of the piezoelectric elements 600 is applied to the ink In in the steady state shown in FIG. 5A, whereby the ink surface is brought into a state in which the ink surface is projected downward from the opening Na of the nozzle N (see FIG. 5B). When application of the pressure P is stopped (or a negative pressure is applied) in the state of FIG. 5B, the ink surface is returned to the state of the FIG. 5A.

The ink ejector 21b repeatedly performs the projecting action in FIG. 5A and FIG. 5B at a frequency corresponding to the drive signals.

As shown in FIG. 1, the head units 20 are individually movable in the X direction. Thus, when an image is not being formed, the nozzle opening surface 21a can be moved to a position facing the maintenance unit 30. FIG. 1 shows a state in which the head unit 20K is moved in the X direction and faces the maintenance unit 30. Hereinafter, the position of the head units 20 during ink ejection for image formation is also referred to as an ink ejection position, and the position facing the maintenance unit 30 is also referred to as a maintenance position.

The maintenance unit 30 is disposed at such a position as to be able to clean the nozzle opening surface 21a when the head unit 20 is moved in the X direction. The maintenance unit 30 may be provided individually for each head unit 20, or the maintenance of all the head units 20 may be performed by a single maintenance unit 30 that moves in the Y direction.

FIG. 6 shows a configuration of the maintenance unit 30. FIG. 6 is a front view of one ink ejection head 21 in the head unit 20 which has been moved to the maintenance position and the maintenance unit 30 that faces the ink ejection head 21, as viewed from the Y direction.

The maintenance unit 30 includes a base 31 and a wiping member 32 attached to the upper surface of the base 31 (the surface facing the ink ejection head 21). The maintenance unit 30 performs a wiping action to wipe and remove ink or other contaminants adhering to the nozzle opening surface 21a of the ink ejection head 21 by the wiping member 32, thereby cleaning the nozzle opening surface 21a.

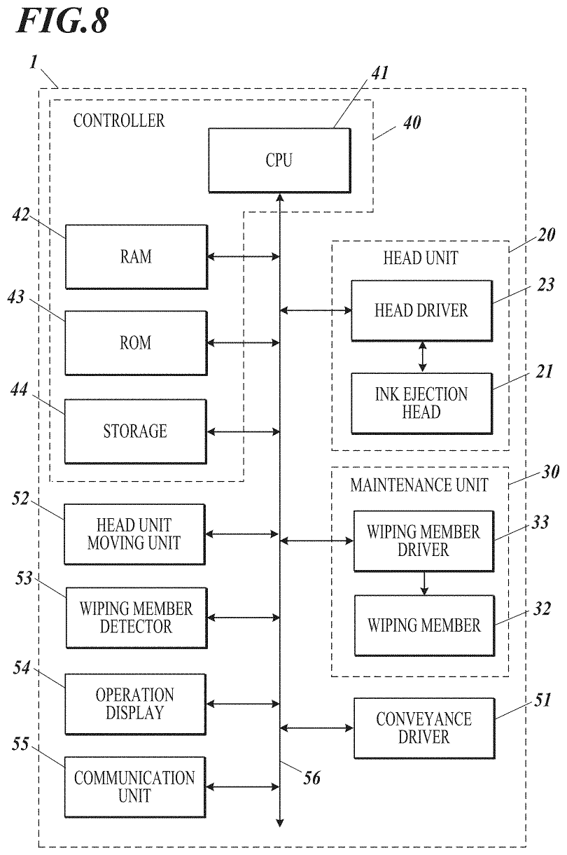

The wiping member 32 is reciprocally movable in the X direction by a wiping member driver 33 (FIG. 8) provided in the base 31. The wiping member 32 is driven by the wiping member driver 33 to move in the X direction in a state where the tip is in contact with the nozzle opening surface 21a, thereby wiping from one end to the other end in the X direction of the nozzle opening surface 21a. The wiping member 32 has a length that covers the width of the head unit 20 in the Y direction, and can wipe the nozzle opening surface 21a of all the ink ejection heads 21 provided in the head unit 20 by one movement in the X direction. The moving speed of the wiping member 32 in the wiping action is not particularly limited, but may be, for example, about 50 mm/sec.

FIG. 6 illustrates an example in which the wiping member 32 is inclined with respect to the normal line of the nozzle opening surface 21a, but the configuration is not limited thereto, and the wiping member 32 may be provided perpendicularly to the nozzle opening surface 21a.

A blade made of an elastically deformable member such as urethane or rubber can be used as the wiping member 32. However, the material of the wiping member 32 is not limited thereto, and a porous material made of a resin such as polyolefin, or a variety of fabrics, sponges, or the like may be used.

The shape of the wiping member 32 is not limited to a shape with a rectangular cross section in the XZ plane as shown in FIG. 6, and may be, for example, a shape with a rounded tip.

The maintenance unit 30 is movable in the Z direction in FIG. 6 (vertical direction). The tip of the wiping member 32 comes into contact with the nozzle opening surface 21a as the maintenance unit 30 moves in the +Z direction (upward direction) when the head unit 20 is in the maintenance position. When the nozzle opening surface 21a is not wiped by the wiping member 32, the maintenance unit 30 moves in the −Z direction (downward direction), and the tip of the wiping member 32 is separated from the nozzle opening surface 21a. Hereinafter, the position of the maintenance unit 30 when the tip of the wiping member 32 and the nozzle opening surface 21a are in contact with each other is referred to as a wiping position, and the position of the maintenance unit 30 when the tip of the wiping member 32 and the nozzle opening surface 21a are separated from each other is referred to as a standby position.

The wiping member 32 in the maintenance unit 30 may be movable in the Z direction with respect to the base 31 so that contact and separation of the tip of the wiping member 32 and the nozzle opening surface 21a is changeable. Alternatively, the head unit 20, instead of the maintenance unit 30, may be movable in the Z direction.

The inkjet recording apparatus 1 has a wiping member detector 53 (detector) for detecting the position of the wiping member 32 in the X direction in the maintenance unit 30.

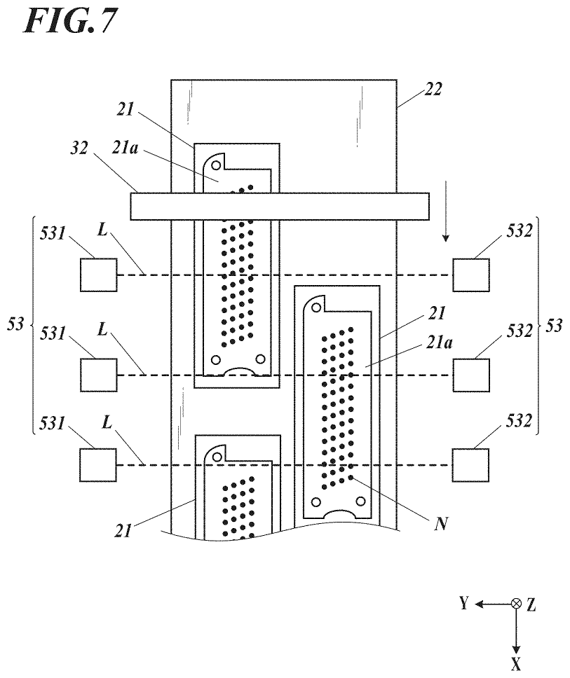

FIG. 7 shows a configuration of the wiping member detector 53. FIG. 7 shows the head unit 20, the wiping member 32, and the wiping member detector 53 as viewed from the −Z direction.

The wiping member detector 53 includes a plurality of detection mechanisms each composed of a pair of a light emitter 531 and a light receiver 532, and the plurality of detection mechanisms are provided at different positions in the X direction. The light emitter 531 emits directional light L to form an optical path along the nozzle opening surface 21a. The light receiver 532 detects the light L emitted from the light emitter 531 and outputs the detection result to the controller 40. The detection result output from the light receiver 532 to the controller 40 is a mode of positional information related to the wiping position. The light emitter 531 and the light receiver 532 are disposed so that the optical path of the light L overlaps the movement path of the wiping member 32. Therefore, the position of the wiping member 32 can be specified based on the timing at which the light L is blocked by the wiping member 32 and the light L is not detected by the light receiver 532. The position of the wiping member 32 when it is between adjacent detection mechanisms may be supplemented from the time difference between when the wiping member 32 is detected by the adjacent detection mechanisms, or may be calculated from the latest detection timing of the wiping member 32 by the detection mechanism and the moving speed of the wiping member 32.

FIG. 8 is a block diagram showing a main functional configuration of the inkjet recording apparatus 1.

The inkjet recording apparatus 1 includes a controller 40, a head unit 20 having an ink ejection head 21 and a head driver 23, a maintenance unit 30 having a wiping member 32 and a wiping member driver 33, a conveyance driver 51, a head unit moving unit 52, a wiping member detector 53, an operation display 54, a communication unit 55, and a bus 56. The components of the inkjet recording apparatus 1 are connected by the bus 56.

The controller 40 is a processor that integrally controls the operation of the inkjet recording apparatus 1. The controller 40 includes a CPU 41 (Central Processing Unit), a RAM 42 (Random Access Memory), a ROM 43 (Read Only Memory), and a storage 44.

The CPU 41 reads out various control programs and setting data stored in the ROM 43, stores the read-out programs and setting data in the RAM 42, and executes the programs to perform various kinds of processing.

The RAM 42 provides the CPU 41 with a work memory space and stores temporary data. The RAM 42 may include a non-volatile memory.

In the ROM 43 various control programs executed by the CPU 41, setting data, and the like are stored. A rewritable non-volatile memory such as a flash memory may be used instead of the ROM 43.

The storage 44 stores image data to be recorded, job data including operation settings related to the recording operation of the image data, and the like input from an external device via the communication unit 55. For example, an HDD (Hard Disk Drive) is used as the storage 44, and a DRAM (Dynamic Random Access Memory), or the like may be used in combination.

The head driver 23 outputs image data and a control signal to the ink ejection head 21 at an appropriate timing according to the rotation movement of the conveyance belt 11 based on a control signal from the controller 40, thereby causing the ink ejectors 21b of the ink ejection head 21 to eject ink from the nozzles N.

The wiping member driver 33 moves the wiping member 32 in the X direction at a timing and at a speed based on the control signal from the controller 40.

The conveyance driver 51 controls the operation of the conveyance motor to which the conveyance roller 12 is attached based on the control signal from the controller 40, rotates each roller, and circularly moves the conveyance belt 11 at a suitable speed.

The head unit moving unit 52, which includes a movement mechanism including a motor for moving the head unit 20, moves the head unit 20 between the ink ejection position and the maintenance position based on the control signal from the controller 40.

The wiping member detector 53 receives the light L from the light emitter 531 by the light receiver 532, and outputs the detection signal to the controller 40.

The operation display 54 includes a display device such as a liquid crystal display or an organic EL display, and an input device such as an operation key or a touch panel overlaid on a screen of the display device. The operation display 54 displays various types of information on the display device, and converts a user operation on the input device into an operation signal and outputs the operation signal to the controller 40.

The communication unit 55 communicates with an external device to transmit and receive information. The communication unit 55 controls communication in conformity with various communication standards relating to wired or wireless LAN communication. The data to be received includes the job data described above. The data to be transmitted includes status information related to the progress of the image recording operation according to the job data.

The bus 56 is a signal path for transmitting and receiving signals between the controller 40 and each component.

### <Maintenance Operation (First Method)>

Next, the maintenance operation for cleaning the nozzle opening surface 21a by the maintenance unit 30 is described in detail.

In the maintenance operation according to the present embodiment, the ejecting action is performed in parallel with the wiping action by the wiping member 32. The ejecting action is performed by the ink ejector 21b that has the nozzle N within a predetermined vicinity range from the contact position of the wiping member 32 on the nozzle opening surface 21a (specifically, the position in the X direction of the front end of the contact area of the wiping member 32 on the nozzle opening surface 21a). Hereinafter, the contact position of the wiping member 32 is referred to as a “wiping position”.

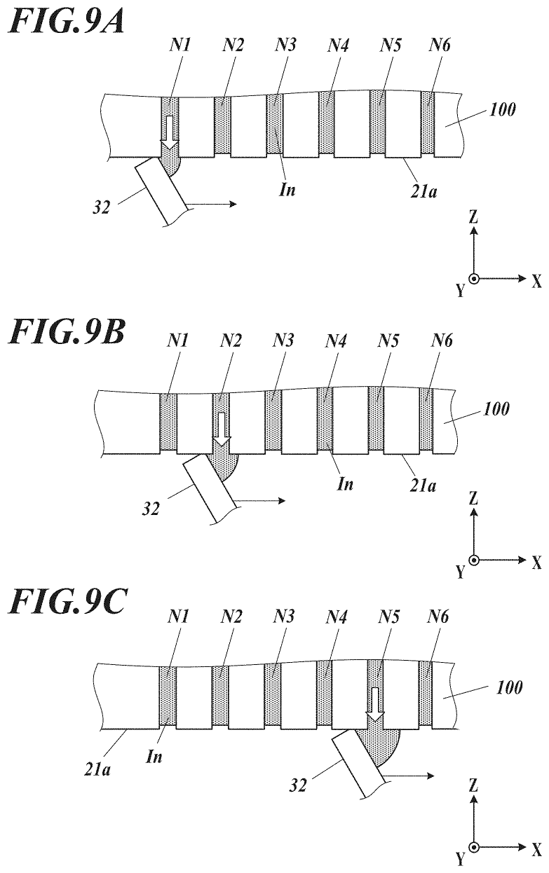

FIG. 9A to FIG. 9C illustrates the maintenance operation.

FIG. 9A to FIG. 9C are cross-sectional views of one of the four nozzle rows of the ink ejection head 21. Hereinafter, the maintenance operation is described focusing on the one nozzle row, but the same operation is performed on the other nozzle rows in parallel.

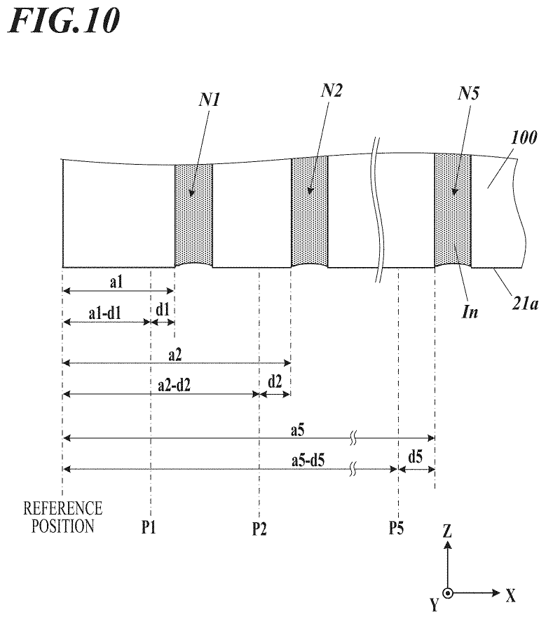

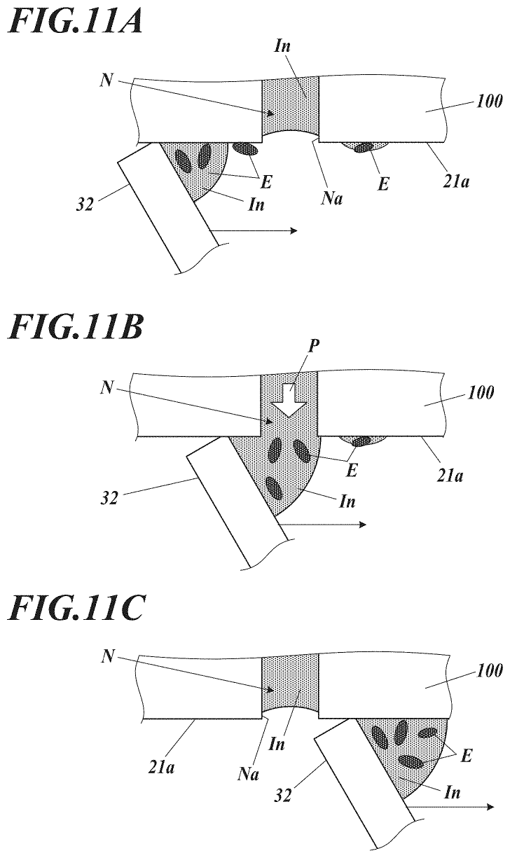

FIG. 10 illustrates the start timing of the ejecting action of the nozzles N in the maintenance operation.

In FIG. 10, distances a1, a2, . . . , and an (n is a nozzle number) from a reference position in the X direction to the respective nozzles N are shown in FIG. 10. The reference position is the wiping position at the start of the wiping action.

Hereinafter, the maintenance operation is described with reference to FIG. 9A to FIG. 9C and FIG. 10.

When the maintenance operation is started, as shown in the FIG. 9A, the wiping member 32 moves in the X-direction in contact with the nozzle opening surface 21a. Then, when the distance in the X direction between the wiping position and the opening of the first nozzle N1 in the X direction gets within a distance d1 (reference distance), the ejecting action by the ink ejector 21b with the said nozzle N1 is started. Hereinafter, the ejecting action by the ink ejector 21b is simply referred to as “ink ejection from the nozzle N”.

That is, when the wiping position reaches the position P1 shown in FIG. 10, ink ejection from the nozzle N1 is started. In other words, where the distance from the reference position to the opening Na of the nozzle N1 is a1, ink ejection from the nozzle N1 is started when the wiping member 32 is moved by a distance (a1−d1) from the reference position.

The ink ejection start timing can also be determined based on the time elapsed since the start of the movement of the wiping member 32. Hereinafter, the time required for the wiping member 32 to move the distance D is represented by t(D). The time t(D) is another mode of positional information concerning the wiping position. The wiping member 32 reaches the position P1 when a time t(a1−d1) has elapsed since the start of the wiping action. That is, the ejection of ink from the nozzle N1 may be started when a time t(a1−d1) has elapsed since the start of the wiping action.

In the stage shown in FIG. 9A, while ink ejection from the nozzle N1 is started, ink is not ejected from the nozzles N located in the +X direction of the nozzle N1.

The frequency of ink ejection in the maintenance operation may be the same as that in the image recording (for example, 30 kHz), or may be lower than that in the image recording as long as foreign substances (described later) E can be removed.

Next, when the wiping member 32 further moves in the X direction and the distance between the wiping position and the opening of the second nozzle N2 in the X direction gets equal to or less than a distance d2 (reference distance), ink ejection from the second nozzle N2 is started as shown in FIG. 9B.

That is, when the wiping position reaches the position P2 shown in FIG. 10, ink ejection from the nozzle N2 is started. In other words, where the distance from the reference position to the opening Na of the nozzle N2 is a2, ink ejection from the nozzle N2 is started when the wiping member 32 is moved by a distance (a2−d2) from the reference position. Ink ejection from the nozzle N2 may be started when t(a2−d2) has elapsed since the start of the wiping action.

In the stage shown in FIG. 9B, ink is not ejected from the nozzles N located in the +X direction from the nozzle N2.

Ink ejection from the nozzle N1 is ended when the wiping member 32 passes through the nozzle N1. Specifically, ink ejection from the nozzle N1 is stopped after ink ejected from the nozzle N1 is not swept by the wiping member 32 anymore. More specifically, the ink ejection from the nozzle N1 is ended before the timing at which at least part of the opening Na of the nozzle N1 does not overlap with the wiping member 32 in a view from the Z direction, that is, the timing at which at least part of ejected ink is not received by the wiping member 32 and flies downward. Therefore, in the state shown in FIG. 9B, ink is not ejected from the first nozzles N1.

When the wiping member 32 further moves in the X direction and, for example, the distance between the wiping position and the opening of the fifth nozzle N5 in the X direction becomes equal to or less than the distance d5 (reference distance), ink ejection from the fifth nozzle N5 is started as shown in FIG. 9C.

That is, when the wiping position reaches the position P5 shown in FIG. 10, ink ejection from the nozzle N5 is started. In other words, the ejection of ink from the nozzle N5 is started when the wiping member 32 moves by a distance (a5−d5) from the reference position, where the distance from the reference position to the opening Na of the nozzle N5 is a5. Alternatively, the ejection of ink from the nozzle N5 may be started when t(a5−d5) has elapsed since the start of the wiping action.

In the stage shown in FIG. 9C, ink is not ejected from the nozzles N located in the +X direction from the nozzle N5 and from the nozzles N located in the −X direction from the nozzles N5.

As described above, ink is ejected from the nozzle N at a timing according to the wiping position as the wiping member 32 moves, more specifically, ink is ejected from the nozzle N within a predetermined vicinity range from the wiping position. This can suppresses occurrence of a problem such as adhesion of foreign substances to the nozzle N in the wiping action.

FIG. 11A to FIG. 11C illustrate effects of the maintenance operation according to the present embodiment, which are enlarged views of one of the nozzles N in the cross-sectional view of FIG. 9A and the surrounding part thereof. Hereinafter, the effects of the maintenance operation of the present embodiment is described with reference to FIG. 11A to FIG. 11C.

Ink mist generated by ink ejection from the nozzles N and part of ejected ink are attached on the nozzle opening surface 21a of the ink ejection head 21 in the state before the maintenance operation is started. Such attached ink also includes ink that has been thickened by evaporation of a solvent or the like. Contaminants other than ink may also be attached on the nozzle opening surface 21a. Hereinafter, such thickened ink and contaminants are referred to as a foreign substance(s) E.

When the nozzle opening surface 21a of FIG. 11A to which the foreign substance E is attached is simply wiped by the wiping member 32, the foreign substance E swept by the wiping member 32 may enter and adhere to the inside of the nozzle N, and left in the nozzle N even after the wiping action is completed. When the foreign substance E adheres to the inside of the nozzle N, the ejection direction and the ejection amount of ink deviate from the original setting, and an ink ejection failure occurs.

In the present embodiment, as shown in FIG. 11B, ink is ejected from the nozzle N that is located within a predetermined vicinity range from the wiping position. As a result, the pressure P for pushing out ink and the foreign substance E to the outside (downward in FIG. 11A to FIG. 11C) is applied to ink in the nozzle N when the wiping member 32 passes therethrough. Accordingly, the foreign substance E is less likely to enter inside the nozzle N, which suppresses occurrence of a problem of adhesion of the foreign substance E to the interior of the nozzle N when the wiping member 32 passes therethrough. In addition, in the nozzle N from which ink is being ejected, the ink surface in the opening Na constantly moves up and down, so that the foreign substance E hardly stays in the opening Na. This also suppresses occurrence of a problem of adhesion of the foreign substance E to the inside of the nozzle N.

Ink is not ejected from the nozzles N which are out of the vicinity range from the wiping position. Since ink in the nozzle N from which ink is not being ejected is pulled upward by a negative pressure as described above, a problem of unintentional dripping of ink is less likely to occur. Accordingly, it is possible to suppress contamination caused by ink mist that is generated by dripping of ink and adheres to the inside of the inkjet recording apparatus 1 including the nozzle opening surface 21a.

The size of the vicinity range (i.e., distances d1, d2, . . . , d5 in FIG. 10, hereinafter collectively referred to as a distance dn (n is the nozzle number)) is defined for each of the plurality of nozzles N. The distance dn is not particularly limited, but the distance dn can be, for example, equal to the area of the nozzle opening surface 21a that is covered with ink swept by the wiping member 32 (ink accumulated around the tip of the wiping member 32 in FIG. 9A to FIG. 9C and FIG. 11A to FIG. 11C, hereinafter referred to as “collected ink”).

In the case in which the distance dn (the vicinity range) is set as described above, ink ejection from the nozzle Nn (n is the nozzle number) is started at the timing when the collected ink reaches the opening Na of the nozzle Nn, so that the action of pushing the foreign substance E in the collected ink to the outside of the nozzle Nn can be reliably obtained. Since ink is not ejected from the nozzle Nn before the collected ink reaches the opening Na of the nozzle Nn, it is possible to suppress ink ejection that does not produce the effect of pushing out the foreign substance E, to reduce the ink consumption, and to suppress contamination of the inside of the inkjet recording apparatus 1 due to ink ejection.

The distance dn can be determined by performing one or more wiping actions in advance and measuring the area of the collected ink at the point in time when the wiping position has advanced to the vicinity of the nozzle Nn. Alternatively, the distance dn may be calculated from the amount of ink attached to the nozzle opening surface 21a or the like. The set value of the distance dn is stored in the storage 44 along with the set value of the distance an and the like, and is looked during the maintenance operation.

As shown in FIG. 9A to FIG. 9C and FIG. 11A to FIG. 11C, the volume of the collected ink increases as the wiping member 32 moves further downstream in the wiping direction (the moving direction of the wiping member 32), and the area of the nozzle opening surface 21a covered with the collected ink increases. Therefore, it is desirable that the distance dn concerning the nozzle Nn be increased as the nozzle Nn is positioned further downstream in the wiping direction. In other words, it is desirable that the start timing t(an−dn) of ink ejection from the nozzle Nn becomes earlier as the nozzle Nn is positioned further downstream.

Instead of the configuration in which a more downstream nozzle Nn has a longer distance dn, the distance dn corresponding to each nozzle Nn may be monotonically non-decreasing with respect to the position coordinate each nozzle Nn in the axis (X axis) along the wiping direction of the wiping member 32 is the positive direction. That is, the distance dn may be increased in a stepwise manner in every two or more nozzles Nn.

### <Maintenance Operation (Second Method)>

In the first method described above, the ejecting action by the ink ejection unit 21b (ink ejection from the nozzle N) is performed in parallel with the wiping action by the wiping member 32, but the projecting action may be performed instead of the ejecting action in the maintenance operation. Hereinafter, the projecting action by the ink ejection unit 21b is simply referred to as “the projecting action is performed in the nozzle N”.

The effect of suppressing adhesion of the foreign substance E to the inside of the nozzle N can also be obtained by the projecting action in the nozzle N, similarly to the first method. This is because the surface of ink in the opening Na of the nozzle N moves up and down, so that the foreign substance E hardly stays in the opening Na, and because the pressure P is applied to ink due to the fluctuation, so that ink and the foreign substance E are pushed out of the nozzle N when the wiping member 32 passes therethrough. Since the wiping member 32 passes in a state where ink is projected from the opening Na of the nozzle N, the foreign substance E in the protruding ink can be easily swept by the wiping member 32.

The frequency of the projecting action of ink may be the same as that in image recording, or may be a frequency lower than that in image recording as long as the foreign substance(s) E can be removed.

In the case where the projecting action is performed in the maintenance operation, the projecting action may be continued until the wiping member 32 passes through the nozzle N and at least a part of the opening Na of the nozzle N does not overlap the wiping member 32 in a view from the Z direction. This is because ink does not normally drip from the nozzle N in the projecting action, and contamination due to the dripping of ink is unlikely to occur. However, since ink is easily dropped from the nozzle N during the projecting action as compared with the nozzle N that is not in the projecting action, it is desirable to end the projecting action immediately after the wiping member 32 passes through the nozzle N.

### <Maintenance Process>

Next, a maintenance process for performing the above-described maintenance operation is described.

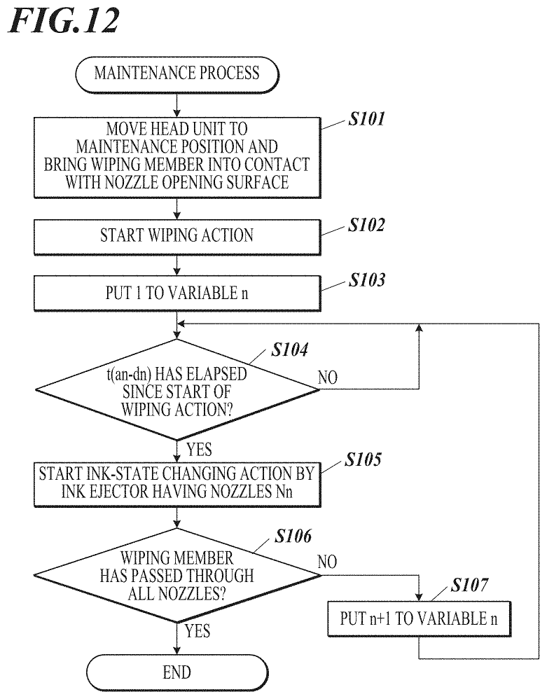

FIG. 12 is a flowchart showing control steps of the maintenance process by the controller 40.

Here, the maintenance process is described based on an example in which the ink-state changing action (ejecting action or projecting action) by the ink ejector 21b is started based on the elapsed time since the start of the wiping action by the wiping member 32.

When the maintenance process is started, the controller 40 supplies control signals to the head unit moving unit 52 to move the head unit 20 to the maintenance position, moves the wiping member 32 in the +Z-direction to bring it into contact with the nozzle opening surface 21a at a predetermined reference position (Step S101).

The controller 40 supplies control signals to the wiping member driver 33 to move the wiping member 32 in the X-direction, thereby starting the wiping action (Step S102). The controller 40 starts measuring the elapsed time since the start of the wiping action.

The controller 40 puts 1 to the variable n corresponding to the nozzle number (Step S103).

The controller 40 determines whether or not t(an−dn) has elapsed since the start of the wiping action (Step S104), and if t(an−dn) has not elapsed yet (NO at step S104), the controller 40 repeats Step S104.

If t(an−dn) has elapsed since the start of the wiping action (“YES” at Step S104), the controller 40 causes the ink ejector 21b having the nozzles Nn to start the ink-state changing action (ejecting action or projecting action) (Step S105: ink control step). The controller 40 ends the ink-state changing action at a predetermined time after the start of the ink-state changing action. The process of ending the ink-state changing operation is performed in parallel with the steps following Step S106.

The controller 40 determines whether or not the wiping member 32 has passed through all the nozzles N (i.e., whether or not t(an) has elapsed since the start of the wiping action) (Step S106), and if at least one of the nozzles N has not passed yet (“NO” at Step S106), puts n+1 to the variable n (Step S107), and returns the process to Step S104.

If the wiping member 32 has passed through all the nozzles N (“YES” in step S106), the controller 40 ends the maintenance process.

Next, some modifications of the above embodiment are described.

### <Modification 1>

In the maintenance process, the ink-state changing action of the ink ejector 21b may be started based on the detection result of the position of the wiping member 32 by the wiping member detector 53.

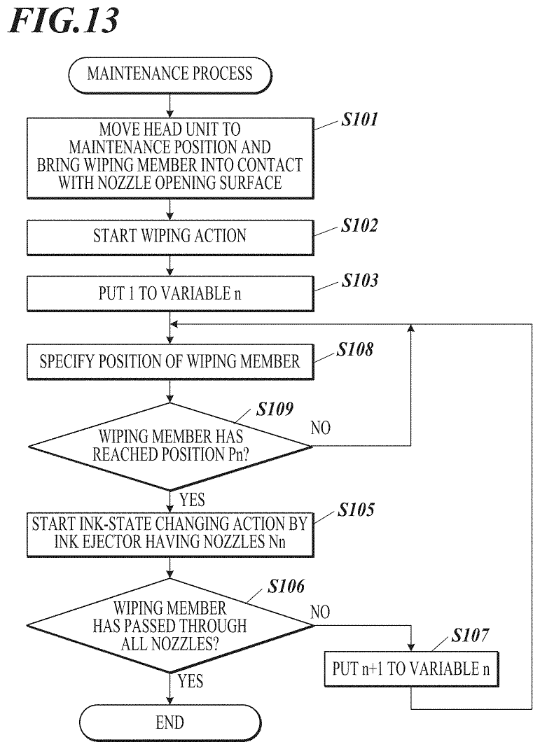

FIG. 13 is a flowchart showing control steps by the controller 40 of the maintenance process according to the present modification.

The flowchart of FIG. 13 is the same as the flowchart of FIG. 12 except that Steps S108 and S109 are added in place of Step S104. Differences from the flowchart of FIG. 12 are described below.

In the maintenance process according to the present modification, when the process at Step S103 is completed, the controller 40 specifies the position of the wiping member 32 by the above-described method based on the detection data from the wiping member detector 53 (Step S108).

The controller 40 determines whether or not the wiping member 32 has reached the position Pn (the position at the distance an−dn from the reference position in the X-direction) (Step S109), and if the wiping member 32 has not reached the position Pn (“NO” at Step S109), the process returns to Step S108.

If the wiping member 32 has reached the position Pn (“YES” at Step S109), the controller 40 executes Step S105 and subsequent steps.

### <Modification 2>

In the above-described embodiment, the start timing of ink ejection is earlier at a more downstream nozzle N since the collected ink is increased as the wiping member 32 moves further downstream in the wiping direction. However, instead of or in addition to this, the amount of ink ejected from each of the nozzles N by a single ejecting action (the amount of ink droplets) may be increased as the nozzle N is positioned further downstream in the wiping direction. If the projecting action is performed instead of the ejecting action in the maintenance operation, the projection amount of ink in the projecting action may be increased as the nozzle N is positioned further downstream.

Instead of the ejection amount or the projection amount of ink of each of the nozzles N being increased as the nozzle N is positioned further downstream, the ejection amount or the projection amount of ink of each nozzle N may be monotonically non-decreasing with respect to the position coordinate of each nozzle N in the axis (X axis) along the wiping direction by the wiping member 32. That is, the ejection amount or the protrusion amount of ink may be increased in a stepwise manner in every two or more ink ejectors 21b.

When the ejection amount or the protrusion amount of ink is increased, the effect of pushing the foreign substance E to the outside of the nozzle N is improved. Thus, it is possible to surely push the foreign substance E out of the nozzle N against the collected ink which is increased toward the downstream side.

As described above, the inkjet recording apparatus 1 according to the present embodiment includes the ink ejection head 21 that includes the ink ejector 21b with the nozzles N to which ink is supplied, the controller 40 that causes the ink ejector 21b to perform at least one of the ejecting action of ejecting ink from the nozzle N and the projecting action of projecting ink from the opening Na of the nozzle N, and the maintenance unit 30 that performs the wiping action of wiping the nozzle opening surface 21a of the ink ejection head, on which the opening Na of the nozzle N is formed. The controller 40 controls the operation of the ink ejector 21b so as to cause the ink ejector 21b to perform the ejecting action and/or the projecting action at the timing corresponding to the wiping position of the maintenance unit 30 during the wiping action.

With such a configuration, when the wiping member 32 (and ink swept by the wiping member 32) passes through the nozzle N, the pressure P for pushing ink and the foreign substance E out of the opening Na is applied to ink in the nozzle N. Accordingly, the foreign substance E is less likely to enter inside of the nozzle N, which can suppress occurrence of a problem of the foreign substance E adhering to the inside of the nozzle N in the wiping action.

As the ejecting action and the projecting action are not performed in the nozzles N outside the vicinity range from the wiping position, it is possible to reduce the occurrence of a problem of unintentional dripping of ink from the nozzles N. Therefore, it is possible to suppress contamination caused by ink mist that is generated by dropping of ink or part of the dropped ink and adheres to the inside of the inkjet recording apparatus 1 including the nozzle opening surface 21a after the wiping. Thus, it is possible to effectively clean the nozzle opening surface 21a while suppressing contamination of the inside of the inkjet recording apparatus 1.

The controller 40 acquires positional information concerning the wiping position, and determines the timing at which the ink ejector 21b performs the ejecting action and/or the projecting action based on the wiping position specified by the positional information. This makes it possible to cause each ink ejector 21b to perform the ejecting action or the projecting action at an appropriate timing according to the position of the wiping member 32. Thus, adhesion of the foreign substance E to the inside of the nozzle N can be suppressed more reliably.

By using the information on the elapsed time since the maintenance unit 30 starts the wiping action as the positional information, the position of the wiping member 32 can be specified by a simple process.

The inkjet recording apparatus 1 according to Modification 1 includes the wiping member detector 53 that detects the wiping position, and the positional information is a result of detection by the wiping member detector 53. This makes it possible to specify more accurately the position of the wiping member 32.

The ink ejection head 21 has a plurality of the ink ejectors 21b, and a plurality of the nozzles N of a plurality of the ink ejectors 21b are disposed over a predetermined range in the X direction on the nozzle opening surface 21a. The maintenance unit 30 wipes the nozzle opening surface 21a in the X direction. The controller 40 starts the ejecting action and/or the projecting action by the ink ejector 21b having the nozzles Nn at a timing when the distance in the X direction between the wiping position and the opening Na of the nozzles Nn gets within a predetermined distance dn. This makes it possible to reduce adhesion of the foreign substance E to the inside of the nozzle N by a simple process based on the information concerning the one-dimensional direction.

The distance dn varies depending on the plurality of nozzles Nn, and the distance dn for the plurality of nozzles Nn is monotonically non-decreasing with respect to the position coordinate of the plurality of nozzles Nn in the X-axis along the wiping direction of the maintenance unit 30. This makes it possible to shorten the gap between the timing at which the collected ink reaches the nozzle N and the start timing of the ejecting action or the projecting action by the ink ejector 21b having the concerning nozzle N, in the case where the volume of the collected ink increases and the area covered by the collected ink in the nozzle opening surface 21a increases as the nozzle N is positioned further downstream in the wiping direction. As a result, it is possible to more reliably suppress occurrence of a problem of adhesion of the foreign substance E in the collected ink to the inside of the nozzle N.

The controller 40 in Modification 2 causes each of the plurality of ink ejectors 21b to perform the ejecting action during the wiping action by the maintenance unit 30, causing each of the plurality of ink ejectors 21b to perform the ejecting action such that the amount of ink ejected from each nozzle N in each single ejecting action is monotonically non-decreasing with respect to the position coordinate of each nozzle N in the wiping direction of the maintenance unit 30. In the mode where the volume of the collected ink increases as the wiping member moves further downstream in the wiping direction, the nozzle N is covered with the collected ink having a larger volume as the nozzle N is positioned further downstream. By adjusting the ejection amount of ink as described above, the foreign substance E can be pushed out against the collected ink having a large volume at the nozzle N on the downstream side. Thus, it is possible to suppress adhesion of the foreign substance E to the inside of the nozzle N.

The controller 40 in Modification 2 causes each of the plurality of ink ejectors 21b to perform the projecting action during the wiping action, causing each of the plurality of ink ejectors 21b to perform the projecting action such that the protrusion amount of ink in the nozzle N by the projecting action becomes monotonically non-decreasing with respect to the position component of each nozzle N in the wiping direction. This makes it possible to push out the foreign substance E against the collected ink having a large volume at the nozzle N on the downstream side. Thus, it is possible to suppress adhesion of the foreign substance E to the inside of the nozzle N.

The controller 40 controls the operation of the ink ejector 21b so as to cause the ink ejector 21b having the nozzles N within a predetermined vicinity range from the wiping position of the maintenance unit 30 to perform the ejecting action and/or the projecting action, and the vicinity range is within an area of the nozzle opening surface 21a that is covered with ink wiped by the maintenance unit 30. By setting the vicinity range as described above, the ejecting action or the projecting action in the nozzle N by the ink ejector 21b is started at the timing when the collected ink is applied to the opening Na of the concerning nozzle N, so that the effect of pushing out the foreign substance E remaining in the collected ink to the outside of the nozzle N can be reliably obtained. The ejecting action and the projecting action are not performed by the ink ejector 21b in the nozzle N before the collected ink is applied to the opening Na of the concerning nozzle N. This makes it possible to suppress contamination of the inside of the inkjet recording apparatus 1 caused by the ejecting action and the projecting action since the ejecting action and the projecting action that do not have the effect of pushing out the foreign substance E are suppressed. That is, the ejecting action or the projecting action can be performed in a necessary and sufficient period.

In the maintenance method according to the present embodiment, the wiping action is performed by the maintenance unit 30, and the ejecting action and/or the projecting action is performed by the ink ejector 21b at a timing corresponding to the wiping position of the cleaning unit 30 during the wiping action. This method makes it possible to effectively clean the nozzle opening surface 21a while suppressing contamination of the inside of the inkjet recording apparatus 1.

The present invention is not limited to the above-described embodiment, and various modifications can be made thereto.

For example, although the distance dn corresponds to the area of the nozzle opening surface 21a that is covered by the collected ink, the distance dn is not limited to this, and may be determined based on the material and speed of the wiping member 32, the material of ink, the type of the assumed foreign substance E, and the like. Further, the distance do is the same between all the nozzles Nn.

Modification 1 illustrates an example in which the position of the wiping member 32 is detected by the wiping member detector 53, but alternatively, the front end of the collected ink swept by the wiping member 32 may be detected by the wiping member detector 53, and the ejecting action or the projecting action of each ink ejector 21b may be started based on the tip position.

The above-described embodiment illustrates an example in which the ejecting action or the projecting action is performed by one ink ejector 21b having one nozzle N at each timing, but the start timing and the end timing of the ejecting action or the projecting action by the ink ejector 21b can be independently determined for each ink ejector 21b, and there may be a period in which the ejecting action or the projecting action is performed by two or more ink ejectors in parallel.

The detection method of the wiping member detector 53 is not limited to that in the above-described embodiment, and a contact method, a method using the result of imaging of the wiping member 32, or the like may be used. The method of wiping is not limited to a method of contacting the wiping member 32 to the nozzle opening surface 21a, and a method of wiping without contact such as a method of blowing air to the nozzle opening surface 21a may be used.

The above-described embodiment illustrates an example in which the ink ejection head 21 has a plurality of nozzles N, but the present invention is not limited thereto, and at least one nozzle N may be provided in the ink ejection head 21.

The above-described embodiment illustrates an example in which the surface of ink is fluctuated. However, fluctuation is one of the modes of the projecting action, and the present invention is not limited thereto. Ink may be continuously projected from the opening Na of the nozzle N by contracting the volume of the pressure chamber 201 or the like in the projecting action.

The above-described embodiment illustrates an example in which the ink ejection head 21 operates in a vent mode in which the pressure of ink in the pressure chamber 201 is changed by deforming the piezoelectric element 600 to eject ink, but the present invention is not limited thereto. For example, a shear mode ink ejection head may be used, in which a pressure chamber is provided inside the piezoelectric body and a shear mode displacement is generated in the piezoelectric body on the wall surface of the pressure chamber to change the pressure of ink in the pressure chamber. The method of ejecting ink is not limited to deforming the pressure chamber, and for example, a thermal ink ejection head that ejects ink by generating bubbles in ink by heating may be used.

While several embodiments of the present invention are described, the scope of the present invention is not limited to the above-described embodiments, but includes the scope of the claims and its equivalents.

Although embodiments of the present invention have been described and illustrated in detail, the disclosed embodiments are made for purposes of illustration and example only and not limitation. The scope of the present invention should be interpreted by terms of the appended claims.

1. An inkjet recording apparatus comprising:
an ink ejection head that includes an ink ejector with a nozzle to which ink is supplied;
a hardware processor that causes the ink ejector to perform an ejecting action of ejecting ink from the nozzle and/or an projecting action of projecting ink from an opening of the nozzle; and
a wiping unit that performs a wiping action of wiping a nozzle opening surface of the ink ejection head, the opening of the nozzle being formed on the nozzle opening surface;
wherein the hardware processor controls an operation of the ink ejector so as to cause the ink ejector to perform the ejecting action and/or the projecting action at a timing according to a wiping position of the wiping unit during the wiping action of the wiping unit.

2. The inkjet recording apparatus according to claim 1, wherein the hardware processor acquires positional information concerning the wiping position and determines the timing at which the ejecting action and/or the projecting action is performed by the ink ejector based on the wiping position specified by the positional information.

3. The inkjet recording apparatus according to claim 2, wherein the positional information is an elapsed time since the wiping unit starts the wiping action.

4. The inkjet recording apparatus according to claim 2, comprising:
a detector that detects the wiping position,
wherein the positional information is a result of detection by the detector.

5. The inkjet recording apparatus according to claim 1,
wherein the ink ejector comprises a plurality of ink ejectors,
wherein a plurality of nozzles of the plurality of ink ejectors is disposed over a predetermined range in a predetermined direction on the nozzle opening surface,
wherein the wiping unit wipes the nozzle opening surface in the predetermined direction,
wherein at a timing when a distance between the wiping position and the opening of each one of the plurality of nozzles in the predetermined direction gets within a predetermined reference distance, the hardware processor causes the ink ejector having the each one of the plurality of nozzles to start the ejecting action and/or the projecting action.

6. The inkjet recording apparatus according to claim 5,
wherein the reference distance varies depending on the plurality of nozzles,
wherein the reference distance for the plurality of nozzles is monotonically non-decreasing with respect to a position coordinate of the plurality of nozzles in an axis along the wiping direction of the wiping unit.

7. The inkjet recording apparatus according to claim 5,
wherein the hardware processor causes each of the plurality of ink ejectors to perform the ejecting action during the wiping action by the wiping unit,
wherein an amount of ink ejected from the plurality of nozzles in each single ejecting action is monotonically non-decreasing with respect to a position coordinate of the plurality of nozzles in an axis along the wiping direction of the wiping unit.

8. The inkjet recording apparatus according to claim 5,
wherein the hardware processor causes each of the plurality of ink ejectors to perform the projecting action during the wiping action of the wiping unit,
wherein an amount of ink projected from the plurality of nozzles is monotonically non-decreasing with respect to a position coordinate of the plurality of nozzles in an axis along a wiping direction of the wiping unit.

9. The inkjet recording apparatus according to claim 1,
wherein the hardware processor controls an operation of the ink ejector so as to cause the ink ejector having the nozzle within a predetermined vicinity range from the wiping position of the wiping unit to perform the ejecting action and/or the projecting action,
wherein the vicinity range is within an area of the nozzle opening surface that is covered with ink wiped by the wiping unit.

10. A maintenance method of maintaining an inkjet recording apparatus,
wherein the inkjet recording apparatus comprises:
an ink ejection head that includes an ink ejector with a nozzle to which ink is supplied;
a hardware processor that causes the ink ejector to perform an ejecting action of ejecting ink from the nozzle and/or an projecting action of projecting ink from an opening of the nozzle; and
a wiping unit that performs a wiping action of wiping a nozzle opening surface of the ink ejection head, the opening of the nozzle being formed on the nozzle opening surface;
wherein the method comprising:
causing the wiping unit to perform the wiping action; and
causing the ink ejector to perform the ejecting action and/or the projecting action at a timing corresponding to a wiping position of the wiping unit during the wiping action of the wiping unit.
